(19) United States
(12) Patent Application Publication
(10) Pub. No.: US 2004/0118917 A1
(43) Pub. Date: Jun. 24, 2004

(54) Reading head

(76) Inventor: Danis Sangois, Caracas (VE)

Correspondence Address: LACKENBACH SIEGEL LLP, One Chase Road, Scarsdale, NY, 10583, US

(21) Appl. No.: 10/731,650

(22) Filed: Dec. 9, 2003

(30) Foreign Application Priority Data
Dec. 11, 2002 (VE) 02-02423

(51) Int. Cl. G06K 7/06

(52) U.S. Cl. 235/441

(57) ABSTRACT

A reading head furnished by an electromechanical device comprising a series of contact points which are activated by way of pressure provided by a material-base and its elasticity achieving a connection between this one and a surface, establishing signal or energy electronic transference.

### FIELD OF THE INVENTION

In general, the present invention relates to electronic data interchange among data storage devices, reading devices and data handling. More particularly, a data interchange device comprising prepaid telephonic cards and access control cards, etc.

### BACKGROUND OF THE INVENTION

At present, heads used to read telephonic card data, access authorization cards, etc., comprise separated elements to obtain an appropriate operation of the heads. This condition requires special mouldings to manufacture and assembly of the components forming such heads. The pressure mechanical action on contacts which operates as a base to achieve electronic transference loses the initial efficience in the course of time. This condition leads to contact failures which becomes unabled such heads, determining replacement thereof in a relatively short term due to this action is exerted through metal elements. These contacts, which generally are made using very thin metal strips or very thin springs having special configurations are subjected to suffer damaging deformations in spite of having still a useful life.

At present and among the prior art guided to obtain the same purpose we can mention contacts made from tempered metal plates as those used by American Magnetics; end stretched springs used by Hopt & Schuler as well as those having sliding pins and pressure springs used by ETG.

Disadvantages of the above-referred inventions are basically those explained on the first paragraph of this section.

### SUMMARY OF THE INVENTION

The present invention provides a reading head for interchanging electronic data between data storage devices, data reading and handling devices and more specifically, a data interchange device using prepaid telephonic cards, access authorization cards, etc. The present invention can be combined with any type of equipment designed for reading and handling information, for example a public telephone and the prepaid chip-card used in this apparatus. It can be used sole or combined to other data transferring systems.

The present invention deals with an electro-mechanical device having a series of contact points which are activated by way of a pressure generated through elasticity of a material-base which permits to obtain a connection point between this material-base and a surface, being possible to establish signal or energy electronic transference. Such surface contacts can pertain to other equipment or to a data storage device as is the case of chips used in telephonic cards or in access control cards. This connection is obtained through conductive elements located in both extensions of a elastic material which exert pressure on the contact points. This is not a metallic material as in known prior art cases. It is a synthetic material known as FR4 which has been widely used in printed circuits on electronic manufacturing, being a material essentially made of fiberglass and can be coatedvered with very thin copper sheets, as in our invention. Such copper sheets duiy conformed operate as a conductive element from the contact points up to a terminal or a connector coupled to an equipment which drives the data transference.

An advantage of the invention is that such material, not being metallic, allows to obtain a pattern of contacts using a milling machine, from a sheet of FR4 material which can include any distribution of the electronic components and being part of the printed circuit card in the data handling device.

Due to its low cost of manufacture this invention allows that when a failure arises it would be cheaper to replace all the unit involved than replacement of all the head, becoming the reader unit into a disposable unit, saving service costs and associated repairs.

### BRIEF DESCRIPTION OF THE DRAWING

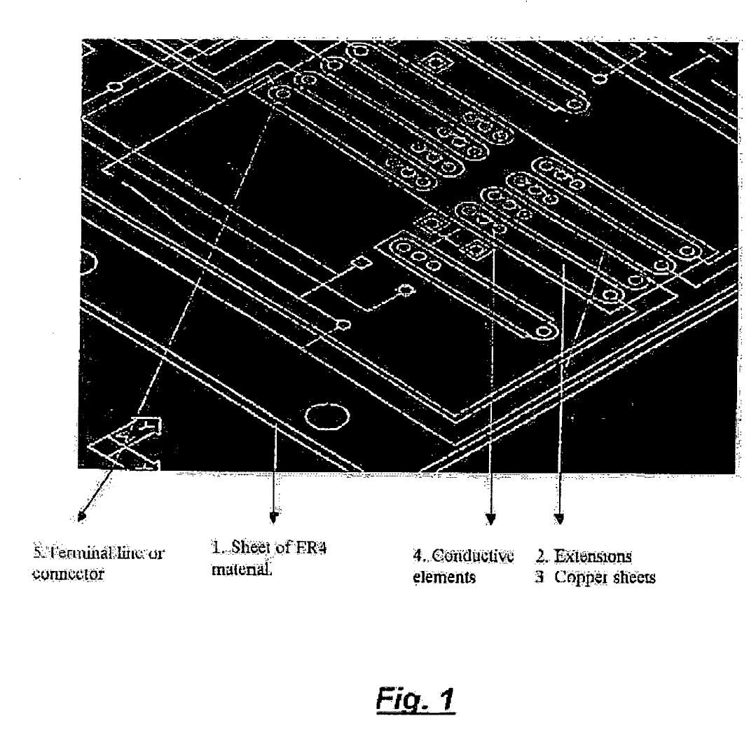

The above referred and other advantages of the present invention would be more evident through the drawing of the FIG. 1, which is an upper view of the invention.

### DETAILED DESCRIPTION OF THE PREFERRED EMBODIMENTS

FIG. 1 shows a reading head made of a sheet of FR4 material 1 having extensions 2, their configured copper sheets 3, conductive elements 4 and their terminal lines or connectors 5, according to a first embodiment comprising eight extensions.

In a second embodiment the conductive elements 4 can be made of a electroplated metal or a synthetic conductive material.

The base sheet 1 is a sole piece and is the same than constitutes the extensions made by way of a milling machine. This base-sheet can be a part of a more complex printed circuit using the same sheet.

The above description of the preferred embodiments has been explained for ilustrative and descriptive purposes.

It is not intended to be exhaustive or limitative to a specific form and obviously can be subjected to many modifications and variations into the scope of the invention. One skilled in the art would be able to find such modifications and variations without departing of the scope of the following claims.

1. A reading head, which comprises:
a sole sheet of FR4 as material-base, obtained by way of a milling machine;
extensions of such material-base which support electroplated metal conductive elements;
configured copper sheets which join the conductive elements to a terminal or connector.

2. The reading head, according to claim 1, wherein the base sheet can be made of any material having an elasticity index enough to achieve pressure on the conductive elements.

3. The reading head, according to claim 1, wherein the base extensions can be formed through a milling machine or through a die.

4. The reading head, according to claim 1, wherein the conductive elements can be of any kind of metal, any kind of electroplating, any conductive synthetic material and any configuration as round, half-moon, semicircular or other.

5. The reading head, according to claim 1, wherein the sheets can be made of other conductive material, wires or a conductive polymer.

6. The reading head, according to claim 1, wherein the terminal or connector is generated from a metallized hole, which also can be a rivet where conductors are connected to lead signal to a control circuit.
